(19) United States
(12) Patent Application Publication
(10) Pub. No.: US 2010/0157461 A1
(43) Pub. Date: Jun. 24, 2010

(54) SIGNAL REPRODUCING CIRCUIT, MAGNETIC STORAGE DEVICE, AND SIGNAL REPRODUCING METHOD

(75) Inventors: Hiroaki UENO, Hachioji-shi (JP); Hiroshi ISOKAWA, Yokohama-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/642,014

(22) Filed: Dec. 18, 2009

(30) Foreign Application Priority Data
Dec. 24, 2008 (JP) 2008-326913

(51) Int. Cl. G11B 5/035

(52) U.S. Cl. 360/65; G9B/5.032

(57) ABSTRACT

According to one embodiment, a signal reproducing circuit reproduces a signal read from a recording medium on which the signal has been recorded by perpendicular magnetic recording. The signal reproducing circuit includes a waveform equalizer that equalizes the waveform of the signal based on a waveform equalization target, where D is a one-bit delay operator, previously stored in a storage module. The waveform equalization target is any one of a[1+3D+2D²] [1−D], a[2+5D+2D²] [1−D], and a[1+4D+2D²] [1−D] where a is an integer.

### CROSS-REFERENCE TO RELATED APPLICATIONS

This application is based upon and claims the benefit of priority from Japanese Patent Application No. 2008-326913, filed Dec. 24, 2008, the entire contents of which are incorporated herein by reference.

### BACKGROUND

1. Field

One embodiment of the invention relates to a signal reproducing circuit, a magnetic storage device, and a signal reproducing method.

2. Description of the Related Art

As for an optimal waveform equalization target in perpendicular magnetic recording, it has been advocated that a waveform equalization target including a direct current (DC) component is excellent in terms of error rate.

Japanese Patent Application Publication (KOKAI) No. 2006-331641 discloses a magnetic recording/reproducing signal processing circuit. The magnetic recording/reproducing signal processing circuit processes a reproduced signal output from a reproducing head through a partial response waveform equalization circuit having frequency characteristics that pass and suppress low frequency signal components including DC components. The magnetic recording/reproducing signal processing circuit then inputs the signal to a maximum likelihood decoder to reproduce data.

As described in, for example, “Adjacent-Track Interference in Dual-Layer Perpendicular Recording,” IEEE Transactions on Magnetics, Vol. 39, No. 4, July 2003, pp. 1891-1896, Wen Jiang et al., in perpendicular magnetic recording, crosstalk of low frequency noise occurs from an adjacent track to an on-track position through a soft magnetic underlayer (SUL). Accordingly, when a signal is reproduced by applying a waveform equalization target including a DC component using a low-frequency component, i.e., a waveform equalization target not including [1−D], the low frequency noise from the adjacent track has an influence on the on-track position, thereby degrading the error rate. Here, D is a one-bit delay operator and means e^{-jωt}.

FIG. 9 illustrates the measurement result of the low frequency noise from the adjacent track. Specifically, FIG. 9 illustrates the (crosstalk) noise amount from the adjacent track when the signal level at the on-track position is 1. In FIG. 9, the horizontal axis represents normalized write frequency and the vertical axis represents side track crosstalk. Referring to FIG. 9, adjacent track DC erasure causes noise of 24% at the on-track position. The crosstalk noise (Vxtk) can be approximated by the following Equation 1:

$$Vxtk = 0.24 {e}^{- ( \frac{f}{ftau} )} \qquad ( 1 )$$

where f is a recording frequency and ftau is a time constant. The noise from the adjacent track represented by Equation 1 appears in lower frequencies and decreases in higher frequencies.

FIG. 10 illustrates a crosstalk noise amount from the adjacent track and the degradation degree of the error rate (ERT). A partial response maximum likelihood (PRML) waveform equalization target is [4+7D+D²] having a DC component. In FIG. 10, the horizontal axis represents common logarithm of ftau in Equation 1 and the vertical axis represents the degradation amount of the error rate (ΔERT). From the measurement result, because ftau is 0.02 (−1.70 by common logarithm), the degradation amount of the error rate (ΔERT) is approximately 0.5 digit. In this way, in the PRML waveform equalization target having a DC component, crosstalk noise appears in low frequencies, and therefore the error rate degrades. In addition, because crosstalk noise from the adjacent track is low frequency noise, error due to this noise causes a long bit error. Accordingly, for example, the error correction ability by known reed solomon error correction code (ECC) or the like provided to a magnetic storage device is lowered. On the other hand, according to other measurement results, when a waveform equalization target including [1−D] is used, the degradation amount of the error rate is 0. The results indicate that the use of a waveform equalization target including [1−D], i.e., a waveform equalization target not including a DC component, is effective to improve the error rate.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram of a configuration of a magnetic recording/reproducing device according to an embodiment of the invention;

FIG. 2 is an exemplary diagram of a configuration of a signal reproducing circuit of the magnetic recording/reproducing device in the embodiment;

FIG. 3 is an exemplary graph of frequency characteristics of a waveform equalization target in the embodiment;

FIG. 4 is an exemplary graph of frequency characteristics of another waveform equalization target in the embodiment;

FIG. 5 is an exemplary graph of frequency characteristics of still another waveform equalization target in the embodiment;

FIG. 6 is an exemplary flowchart of a signal reproducing process in the embodiment;

FIG. 7 is an exemplary graph for explaining the effect of the signal reproducing process by the magnetic recording/reproducing device in the embodiment;

FIG. 8 is an exemplary graph for explaining the effect of the signal reproducing process by the magnetic recording/reproducing device in the embodiment;

FIG. 9 is an exemplary graph of the measurement result of low frequency noise from an adjacent track; and

FIG. 10 is an exemplary graph of a crosstalk noise amount from an adjacent track and the degradation degree of an error rate.

### DETAILED DESCRIPTION

Various embodiments according to the invention will be described hereinafter with reference to the accompanying drawings. In general, according to one embodiment of the invention, a signal reproducing circuit is configured to reproduce a signal read from a recording medium on which the signal has been recorded by perpendicular magnetic recording. The signal reproducing circuit comprises a waveform equalizer configured to equalize the waveform of the signal based on a waveform equalization target, where D is a one-bit delay operator, previously stored in a storage module. The waveform equalization target is any one of a[1+3D+2D²] [1−D], a[2+5D+2D²] [1−D], and a[1+4D+2D²] [1−D] where a is an integer.

According to another embodiment of the invention, a magnetic storage device comprises a signal reproducing circuit configured to reproduce a signal read from a recording medium on which the signal has been recorded by perpendicular magnetic recording. The signal reproducing circuit comprises a waveform equalizer configured to equalize the waveform of the signal based on a waveform equalization target, where D is a one-bit delay operator, previously stored in a storage module. The waveform equalization target is any one of a[1+3D+2D²] [1−D], a[2+5D+2D²] [1−D], and a[1+4D+2D²] [1−D] where a is an integer.

According to still another embodiment of the invention, there is provided a signal reproducing method applied to a signal reproducing circuit configured to reproduce a signal read from a recording medium on which the signal has been recorded by perpendicular magnetic recording. The signal reproducing method comprising the signal reproducing circuit equalizing the waveform of the signal based on a waveform equalization target, where D is a one-bit delay operator, previously stored in a storage module. The waveform equalization target is any one of a[1+3D+2D²] [1−D], a[2+5D+2D²] [1−D], and a[1+4D+2D²] [1−D] where a is an integer.

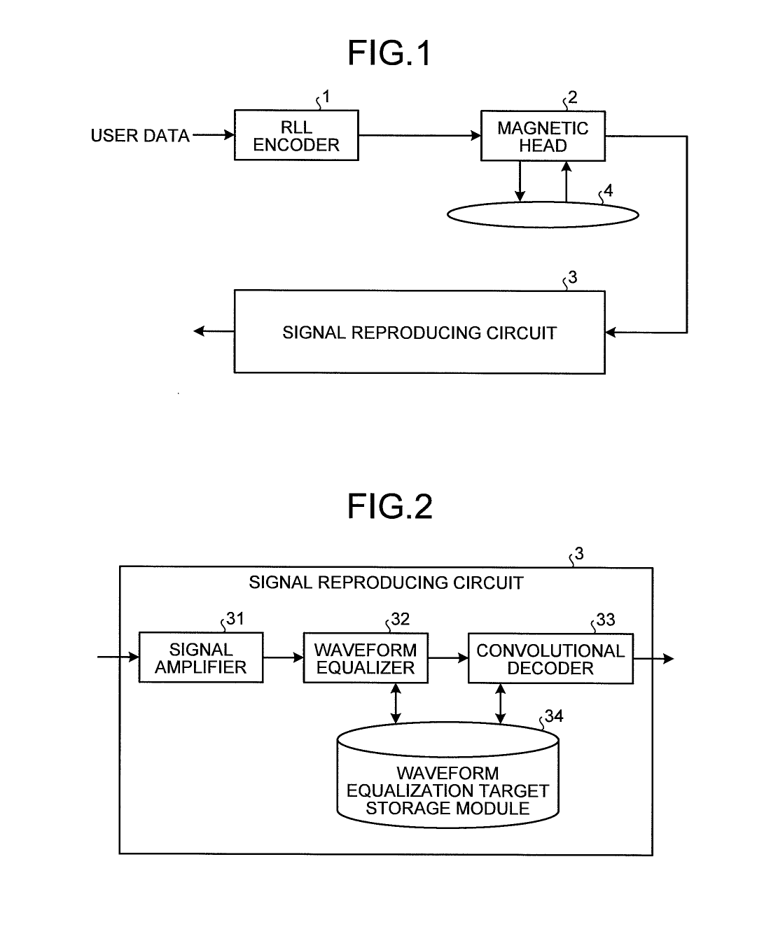

FIG. 1 is a diagram of a configuration of a magnetic recording/reproducing device according to an embodiment of the invention. The magnetic recording/reproducing device of the embodiment is a magnetic storage device and reproduces a signal read from a recording medium 4 on which the signal has been recorded by perpendicular magnetic recording. As illustrated in FIG. 1, the magnetic recording/reproducing device comprises a run length limited (RLL) encoder 1, a magnetic head 2, and a signal reproducing circuit 3.

The RLL encoder 1 encodes user data using a run length limited code and outputs a signal to be written to the recording medium 4. The magnetic head 2 writes the signal output from the RLL encoder 1 to the recording medium 4 by perpendicular magnetic recording. The magnetic head 2 reads a signal written to the recording medium 4 from the recording medium 4 and outputs the signal. The magnetic head 2 writes a signal to the recording medium 4 and reads a signal from the recording medium 4 according to an instruction from a predetermined controller, such as a micro processing unit (MPU) (not illustrated), provided in the magnetic recording/reproducing device of the embodiment. Note that the magnetic recording/reproducing device may use an arbitrary encoder other than the RLL encoder 1.

The signal reproducing circuit 3 reproduces a signal read by the magnetic head 2. Specifically, the signal reproducing circuit 3 uses a waveform equalization target previously stored in a waveform equalization target storage module 34 (see FIG. 2 described later) and including [1−D], where D is a one-bit delay operator, to equalize the waveform of the read signal. In addition, the signal reproducing circuit 3 uses the waveform equalization target to convolutionally decode the waveform-equalized signal, and outputs the convolutionally decoded signal as a reproduced signal.

FIG. 2 is a diagram of a configuration of the signal reproducing circuit 3 of the magnetic recording/reproducing device illustrated in FIG. 1. The signal reproducing circuit 3 comprises a signal amplifier 31, a waveform equalizer 32, a convolutional decoder 33, and the waveform equalization target storage module 34.

The signal amplifier 31 amplifies a signal read and output by the magnetic head 2. The waveform equalizer 32 uses a waveform equalization target previously stored in the waveform equalization target storage module 34 and including [1−D] to equalize the waveform of the amplified signal. Specifically, the waveform equalizer 32 equalizes the waveform of the amplified signal so that the transfer function of the signal read by the magnetic head 2 becomes the waveform equalization target in a system from the output of the magnetic head 2 to the output of the waveform equalizer 32. In the embodiment, the waveform equalization target previously stored in the waveform equalization target storage module 34 is, for example, any one of a[1+3D+2D²] [1−D], a[2+5D+2D²] [1−D], and a[1+4D+2D²] [1−D] (a: an integer). The waveform equalizer 32 uses, for example, any one of the three waveform equalization targets to perform waveform equalization.

Among the waveform equalization targets previously stored in the waveform equalization target storage module 34, the waveform equalizer 32 may select a waveform equalization target having the lowest error rate according to a present normalized linear density Kp in perpendicular magnetic recording. After that, the waveform equalizer 32 may perform waveform equalization using the selected waveform equalization target.

The convolutional decoder 33 uses the waveform equalization target used for waveform equalization to convolutionally decode the signal waveform-equalized by the waveform equalizer 32, and outputs the decoded signal. The convolutional decoder 33 may be, for example, a Viterbi decoder or an iterative decoder. The convolutional decoder 33 may also be a data-dependent noise predictive (DDNP) Viterbi decoder. If a DDNP Viterbi decoder is used as the convolutional decoder 33, Viterbi decoding can be performed taking into account noise depending on a magnetic recording pattern (data pattern). The waveform equalization target storage module 34 previously stores the waveform equalization target including [1−D].

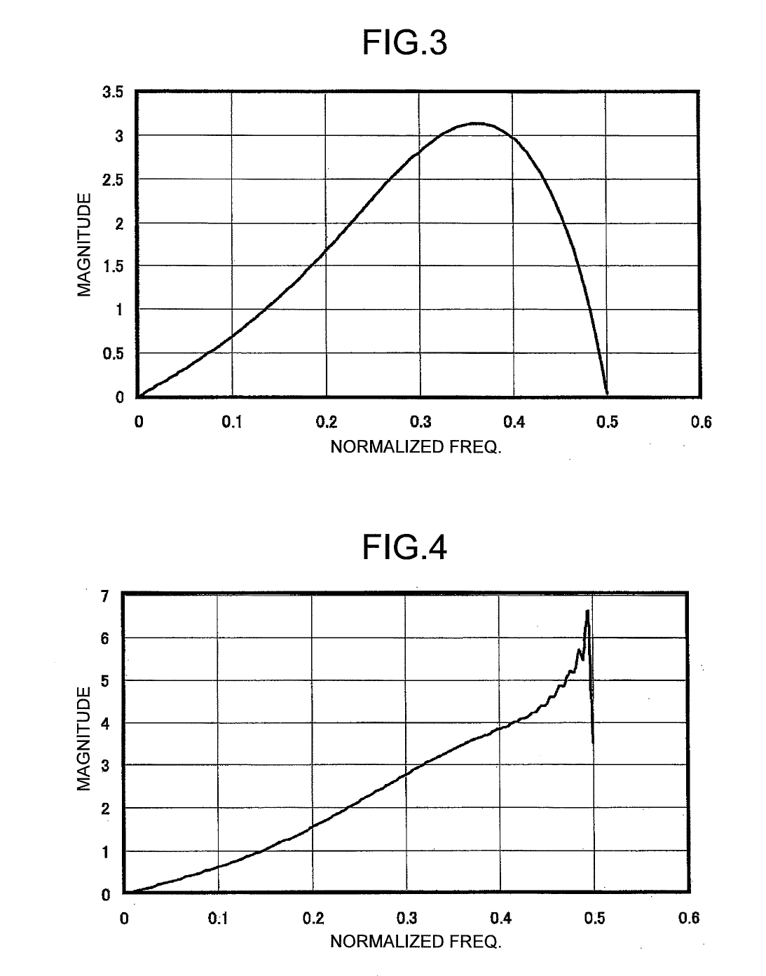

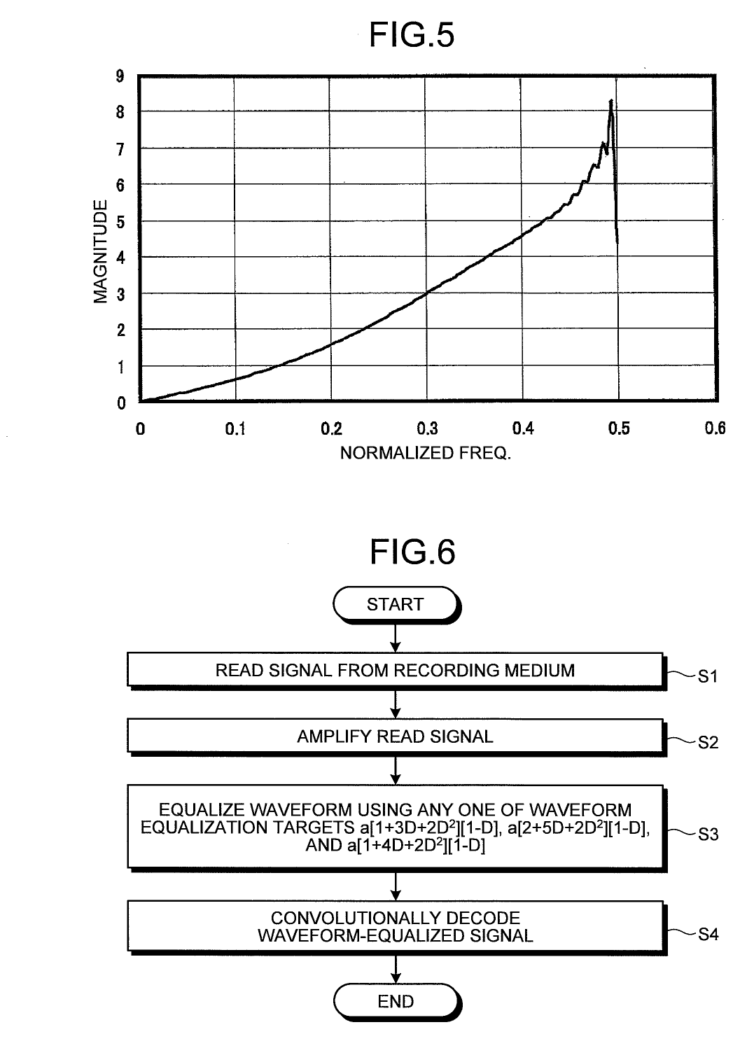

FIG. 3 illustrates frequency characteristics of the waveform equalization target [1+3D+2D²] [1−D]. FIG. 4 illustrates frequency characteristics of the waveform equalization target [2+5D+2D²] [1−D]. FIG. 5 illustrates frequency characteristics of the waveform equalization target [1+4D+2D²] [1−D]. In FIGS. 3 to 5, normalized Freq of the horizontal axis represents normalized frequencies of the waveform equalization targets, and Magnitude of the vertical axis represents magnitudes of the waveform equalization targets. Referring to FIGS. 3 to 5, the waveform equalization targets [1+3D+2D²] [1−D], [2+5D+2D²] [1−D], and [1+4D+2D²] [1−D] suppress (attenuate) low-frequency components. Accordingly, crosstalk noise from an adjacent track that concentrates at the low frequency can be suppressed.

FIG. 6 is a flowchart of a signal reproducing process according to the embodiment. First, the magnetic head 2 read a signal from the recording medium 4 (S1). The signal amplifier 31 amplifies the signal read at S1 (S2). The waveform equalizer 32 equalizes the waveform of the signal amplified at S2 based on a waveform equalization target (for example, any one of a[1+3D+2D²] [1−D], a[2+5D+2D²] [1−D], and a[1+4D+2D²] [1−D]) previously stored in the waveform equalization target storage module 34 (S3). After that, the convolutional decoder 33 convolutionally decodes the waveform-equalized signal based on the waveform equalization target used at S3 (S4), and outputs the convolutionally decoded signal.

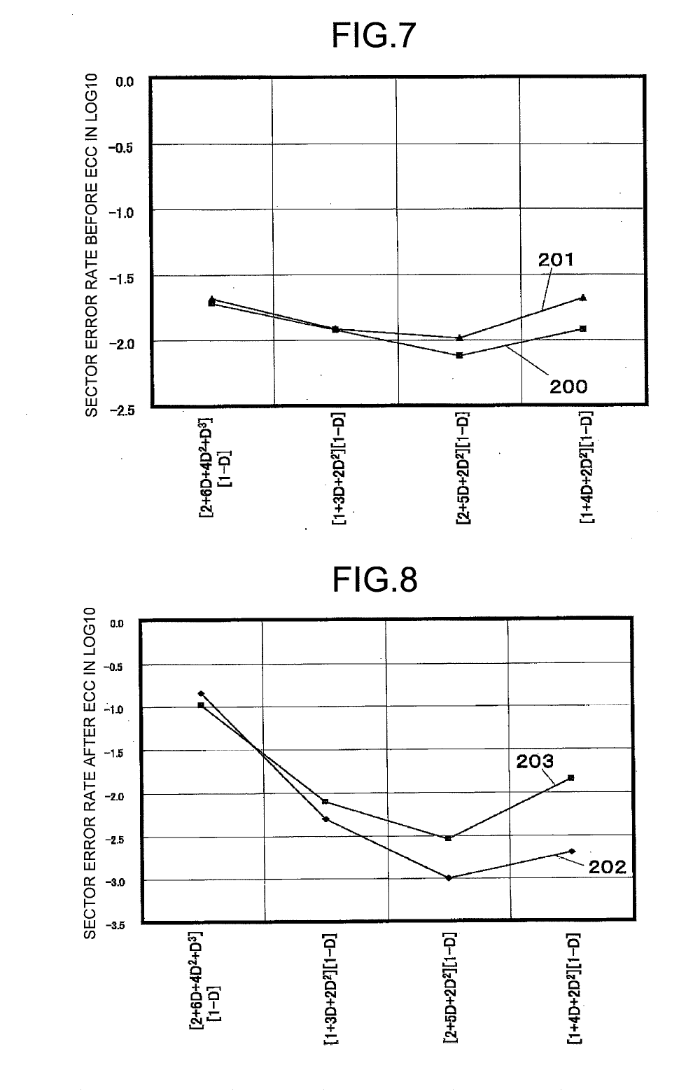

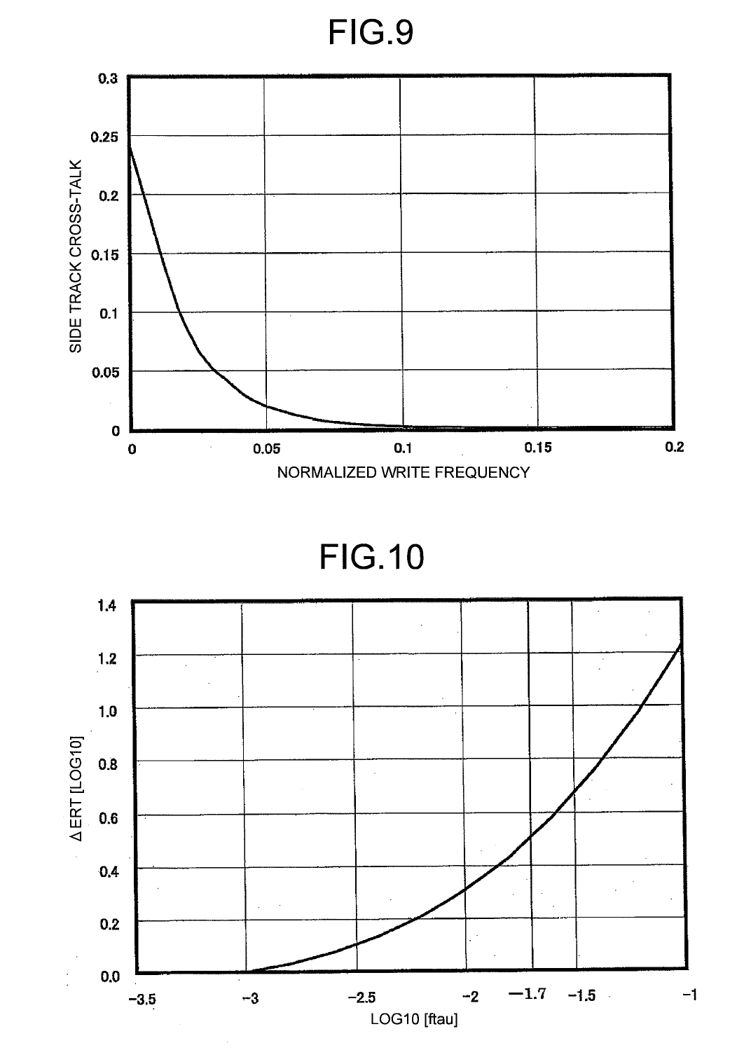

FIGS. 7 and 8 are graphs for explaining the effect of the signal reproducing process performed by the magnetic recording/reproducing device of the embodiment. In FIG. 7, the horizontal axis represents waveform equalization targets used for the signal reproducing process, and the vertical axis represents sector error rate before ECC when the signal reproducing process is performed using each of the waveform equalization targets. In FIG. 8, the horizontal axis represents waveform equalization targets used for the signal reproducing process, and the vertical axis represents sector error rate after ECC when the signal reproducing process is performed using each of the waveform equalization targets. In FIGS. 7 and 8, the horizontal axis represents a conventional waveform equalization target [2+6D+4D²+D³] [1−D] assumed to have excellent error rate performance, and [1+3D+2D²] [1−D], [2+5D+2D²] [1−D], and [1+4D+2D²] [1−D], i.e., examples of the waveform equalization target used by the magnetic recording/reproducing device of the embodiment. In FIG. 7, the sector error rate is 200 when Kp=1.1 and is 201 when Kp=1.2. In FIG. 8, the sector error rate is 202 when Kp=1.1, and is 203 when Kp=1.2.

Referring to FIGS. 7 and 8, when the signal reproducing process is performed using the waveform equalization target used by the magnetic recording/reproducing device of the embodiment, the error rate before ECC can improve by approximately 0.5 digit and the error rate after ECC can improve by approximately 1.5 digits compared with the case of using the conventional waveform equalization target [2+6D+4D²+D³] [1−D].

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A signal reproducing circuit configured to reproduce a signal read from a perpendicular magnetic recording medium, the signal reproducing circuit comprising:
a waveform equalizer configured to equalize a waveform of the signal based on a waveform equalization target in a storage module into a waveform-equalized signal, wherein
the waveform equalization target is any one of a[1+3D+2D²] [1−D], a[2+5D+2D²] [1−D], and a[1+4D+2D²] [1−D] where a is an integer and D is a one-bit delay operator.

2. The signal reproducing circuit of claim 1, further comprising a data-dependent noise predictive Viterbi decoder configured to convolutionally decode the waveform-equalized signal based on the waveform equalization target.

3. A magnetic storage device comprising:
a signal reproducing module configured to reproduce a signal read from a perpendicular magnetic recording medium, the signal reproducing module comprising a waveform equalizer configured to equalize a waveform of the signal based on a waveform equalization target in a storage module into a waveform-equalized signal, wherein,
the waveform equalization target is any one of a[1+3D+2D²] [1−D], a[2+5D+2D²] [1−D], and a[1+4D+2D²] [1−D] where a is an integer and D is a one-bit delay operator.

4. The magnetic storage device of claim 3, wherein the signal reproducing module further comprises a data-dependent noise predictive Viterbi decoder configured to convolutionally decode the waveform-equalized signal based on the waveform equalization target.

5. A signal reproducing method to reproduce a signal read from a perpendicular magnetic recording medium, the signal reproducing method comprising:
equalizing a waveform of the signal based on a waveform equalization target in a storage module into a waveform-equalized signal, wherein,
the waveform equalization target is any one of a[1+3D+2D²] [1−D], a[2+5D+2D²] [1−D], and a[1+4D+2D²] [1−D] where a is an integer and D is a one-bit delay operator.

6. The signal reproducing method of claim 5, further comprising: convolutionally decoding the waveform-equalized signal based on the waveform equalization target.
